(19) United States
(12) Patent Application Publication
(10) Pub. No.: US 2015/0120165 A1
(43) Pub. Date: Apr. 30, 2015

(54) Evaporative Emission Control System Monitoring

(71) Applicant: SGS North America Inc., Rutherford, NJ (US)

(72) Inventors: Gerard P. Glinsky, Jackson, MI (US); Michael St. Denis, Rocklin, CA (US)

(21) Appl. No.: 14/453,294

(22) Filed: Aug. 6, 2014

Related U.S. Application Data
(63) Continuation-in-part of application No. 14/064,934, filed on Oct. 28, 2013.

(51) Int. Cl. G07C 5/00

(52) U.S. Cl. CPC G07C 5/006
USPC 701/101

(57) ABSTRACT

A monitoring sub-system coupled to an evaporative emission canister fluidically coupled to a fuel tank and an engine of a machine includes one or more temperature sensors and a control module coupled to receive sensory output from the temperature sensors. The temperature sensors measure temperature within the evaporative emission canister. The control module is configured to monitor a sorption capacity of the evaporative emission canister based on the received sensory output.

### CLAIM OF PRIORITY

This application is a continuation in part of and claims the benefit of priority to U.S. patent application Ser. No. 14/064,934, filed on Oct. 28, 2013 and entitled “Evaporative Emission Control System Monitoring”, the entire contents of which are hereby incorporated by reference.

### TECHNICAL FIELD

The concepts herein generally relate to monitoring evaporative emission control systems in a vehicle, and have particular application to the field of automobile testing.

### BACKGROUND

Air pollution is a persistent hazard to human health in most urban areas of the world. Components of air pollution which are hazardous to human health include ozone (which is formed by the combination of hydrocarbons and oxides of nitrogen in sunlight) and toxics (which include particular hydrocarbons such as benzene and 1,3-butadiene). It was recognized in in the 1960's that a major source of hydrocarbons is vehicle emissions and since there has been a regulatory focus on the reduction of hydrocarbon emissions from vehicles. The effort is divided into designing new vehicles to have low emissions through advancing emissions control technology and maintenance of these emissions control systems in-use for the lifetime of the vehicle. The US Environmental Protection Agency estimates that approximately half of vehicle emissions of hydrocarbons are due to the leakage of fuel from vehicles (“evaporative” emissions) versus from un-combusted fuel (“tailpipe” emissions). For this reason, ensuring that evaporative emissions control systems continue to function properly throughout the lifetime of a vehicle is critical to the protection of human health.

Recognizing the adverse effects that vehicle emissions have on the environment, the 1990 Clean Air Act requires that communities in geographic regions having high levels of air pollution implement Inspection and Maintenance (“I/M”) programs for vehicles in these areas. Such I/M programs are intended to improve air quality by periodically testing the evaporative and exhaust emissions control systems of vehicles and ensuring their proper operation and maintenance. By ensuring that the evaporative and exhaust emissions control systems of vehicles are operational and properly maintained, air pollution resulting from vehicle emissions in the geographic region are drastically reduced.

In 1992, the California Air Resources Board (CARB) proposed regulations for the monitoring and evaluation of a vehicle's emissions control system through the use of second-generation on-board diagnostics (“OBDII”). (See California Code of Regulations, Title 13, 1968.1—Malfunction and Diagnostic Systems Requirements—1994 and subsequent model year passenger cars, light-duty trucks, and medium-duty vehicles with feedback fuel control systems.) These regulations were later adopted by the United States Environmental Protection Agency. (See Environmental Protection Agency, 40 C.F.R. Part 86—Control of Air Pollution From New Motor Vehicles and New Motor Vehicle Engines; Regulations Requiring On-Board Diagnostic Systems on 1994 and Later Model Year Light-Duty Vehicles and Light-Duty Trucks.) The regulations required OBDII systems to be phased in beginning in 1994, and by 1996, almost all light-duty, gasoline-powered motor vehicles in the United States were required to have OBDII systems. Diesel and alternative fuelled vehicles, and medium and heavy duty vehicles were required to have OBDII systems in the years since initial implementation.

In general, through the use of OBDII systems, the emissions control system of a vehicle is constantly monitored, with a “check engine” light or Malfunction Indicator Light (MIL) on the dashboard of the vehicle being illuminated to indicate a problem with the emissions control system. The OBDII system reduces emissions by indicating an emissions control system malfunction when it occurs so the emissions control system will be repaired, and through interrogation of the OBDII system as part of I/M programs to ensure the emissions control system is functioning properly.

### BRIEF DESCRIPTION OF THE DRAWINGS

FIG. 1 is a diagram of an evaporative emission control system installed on a fuel tank.

FIG. 2 is a flow chart illustrating a method of monitoring an evaporative emission canister.

FIG. 3 is a diagram illustrating an example configuration of multiple temperature sensors positioned within an EVAP canister.

Many of the features are simplified to better show the features, process steps, and results described herein.

### DETAILED DESCRIPTION

OBDII regulations do not require monitoring of the evaporative emission canister, a critical component to the evaporative emission control system. Monitoring of the evaporative emissions canister to identify when the canister is malfunctioning (not capturing the quantity of hydrocarbon vapors as was designed and certified to capture) would identify this source of excess hydrocarbon emissions so that the system could be repaired resulting in significant reductions in hydrocarbon emissions to the environment. The concepts herein relate to determining if the evaporative emissions control canister is malfunctioning.

One or more of the concepts described in the present disclosure are based on a realization that the evaporative emission canister, a critical component to the evaporative emission control system, typically is not monitored for proper functioning. The evaporative emission canister is filled with a material that adsorbs or absorbs hydrocarbon vapor emanating from the fuel tank while the vehicle is resting, or being refueled and then is purged when the vehicle is operating. If the canister is malfunctioning (that is, no longer effectively capturing hydrocarbons), this situation goes unknown to the vehicle operator, engine/vehicle management computer providing On Board Diagnostics (OBD) or regulatory mandated vehicle emissions inspection personnel. The vehicle would continue to be operated with an undetected malfunction causing high evaporative emissions, impacting ambient air quality and human health. Performance of the evaporative emission canister can degrade over time as dust, particulate, moisture and/or other contaminants foul the hydrocarbon absorbent/adsorbent material. The canister may even be rendered completely inoperable if it is physically damaged, if liquid fuel leaks into the canister from the gas tank and completely saturates the material or if the canister material is not purged as a result of other failed components or a poorly designed purge strategy. As described below, monitoring of an evaporative emission canister can be achieved by observing changes in certain environmental conditions of the canister (e.g., temperature) while the canister is in use under specific circumstances. Such changes in the environmental condition of the canister can be correlated to the capacity of the canister to absorb/adsorb hydrocarbons and therefore changes in absorption/adsorption capacity can be detected. Notably, for convenience of reference, the term “sorption” and related forms of the word are meant to describe both absorption and adsorption interactions.

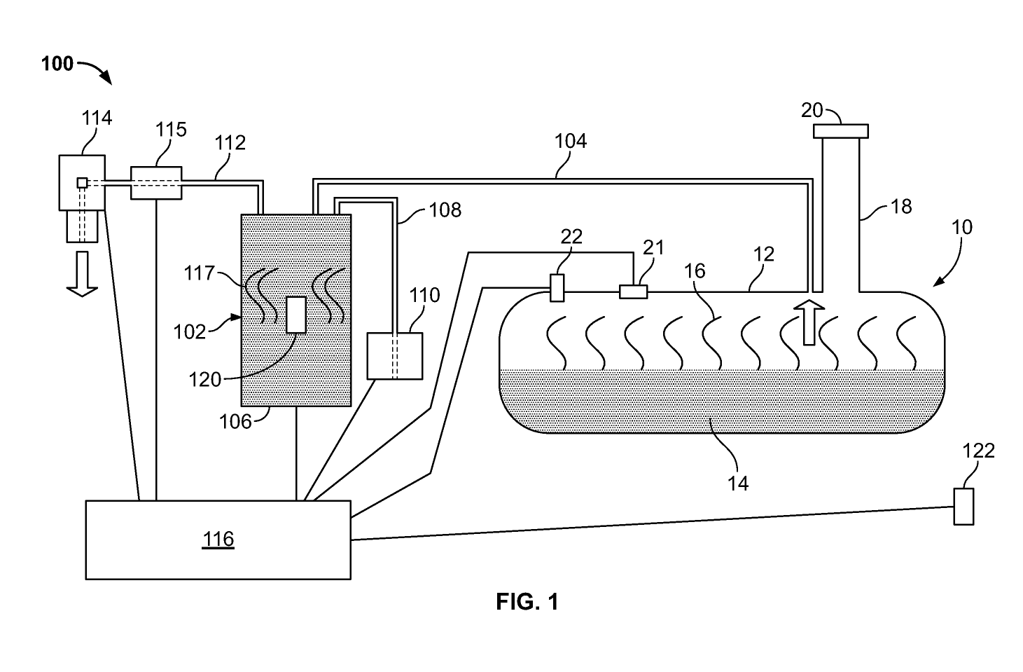

FIG. 1 is a diagram of an example evaporative emission control system (“EVAP”) 100 installed on a fuel tank 10. The evaporative emission control system 100 is adapted to operate within the framework of a motor vehicle (e.g., a car, van, truck, or motorcycle). However, it is appreciated that the concepts described in the present disclosure are not so limited, and can be incorporated in the design of various types of equipment employing internal combustion engines (e.g., stationary engines, air vehicles, marine vehicles, lawn mowers and other types of lawn and garden equipment). Further, while in this example the EVAP 100 is an electronically controlled system, mechanically controlled EVAPs are also well-suited to the concepts described in the present disclosure.

The EVAP 100 includes an evaporative emission canister (“EVAP canister”) 102 connected to the fuel tank 10 by a fuel tank vent line 104. The vent line 104 is depicted as a continuous conduit running from an outlet of the fuel tank 10 to an inlet of the EVAP canister 102. However, it is contemplated that a suitable vent line could include one or more discrete segments connected end-to-end and/or one or more intermediate components (e.g., valves, filters, etc.). The fuel tank 10 includes a fuel storage region 12 for holding liquid volatile fuel 14 (e.g., gasoline) and evaporated fuel vapor 16. A tank-filler neck 18 spouts outward from the storage region 12 of the fuel tank 10. The fuel tank 10 is sealed from the surrounding environment by a gas cap 20 sealing the outlet of the tank-filler neck 18. The sealed gas cap 20 prevents fuel vapors 16 from leaking to the atmosphere through the tank filler neck 18.

As the fuel 14 in the storage region 12 of fuel tank 10 evaporates in the heat of the day from a liquid (14) to a gas (16), it builds a positive tank pressure. Thus, the fuel tank 10 must be vented to prevent fuel leakage and other complications resulting from the positive pressure. Additionally, as the fuel 14 is consumed by the engine, air must be allowed to enter the fuel tank 10 to prevent complications from a reduction in fuel volume (e.g., collapse under negative pressure and/or fuel pump cavitation).

The fuel tank vent line 104 and the EVAP canister 102 facilitate venting of the fuel tank 10. When the fuel tank 10 is under positive pressure from the addition of liquid fuel (“refueling”), increased tank pressure forces fuel vapor 16 to exit the fuel tank 10 via the fuel tank vent line 104. The fuel vapor 16 is routed by the vent line 104 to the EVAP canister 102. A fuel vapor sorbent material 106 within the EVAP canister 102 collects the incoming fuel vapor 16 and allows hydrocarbon free air to escape through the air intake/vent 108. Rapid transfer of fuel vapor 16 from the fuel tank 10 to the EVAP canister 102 during refueling of the vehicle will generally be referred to herein as “loading” the EVAP canister 102 with stored fuel vapors 117.

In some examples, the fuel vapor sorbent material 106 is a carbon-based material. For instance, in at least one example, the fuel vapor sorbent material 106 includes activated charcoal. Other suitable fuel vapor sorbent materials can also be used (e.g., an organic polymer compound such as polypropylene). Within the scope of the present disclosure, “fuel vapor sorbent materials” include materials, such as activated carbon/charcoal, that hold fuel vapors and raw hydrocarbons to a surface, as well as materials that diffuse fuel vapors and raw hydrocarbons into itself.

The EVAP canister 102 includes an air intake/vent 108 controlled by a vent valve 110. In this example, the vent valve 110 is a normally-open electromagnetic valve (e.g., a solenoid valve). The air intake/vent 108 serves to prevent vacuum pressurization of the fuel tank 10 by allowing air to be drawn through the EVAP canister 102 and vent line 104 to supplement consumed fuel or reductions in vapor volume from cooling. The fresh air intake/vent 108 serves to prevent increased pressurization of the fuel tank during refueling or expansion of fuel vapor 16 by allowing the air which has had the hydrocarbons stripped from it and adsorbed/absorbed to the fuel vapor sorbent material 106 to be vented to the atmosphere. Thus, while the vent valve 110 is open, the EVAP canister 102 and the fuel tank 10 are maintained at atmospheric pressure. As described below, the air intake/vent 108 also facilitates purging of stored fuel vapors 117 from the EVAP canister 102.

When the engine is running, stored fuel vapors 117 can be purged from the EVAP canister 102, and routed via a purge line 112 to the engine's intake manifold. “Purging” of the EVAP canister 102 is regulated by a purge valve 114. In this example, the purge valve 114 is a normally closed electromagnetic valve (e.g., a solenoid valve). When the purge valve 114 is opened, the EVAP canister 102 is exposed to the sub-atmospheric pressure of the intake manifold, creating a vacuum effect. The vacuum draws air through the fresh air intake 108 of the EVAP canister 102. The incoming fresh air flows through the EVAP canister 102, releasing (or desorbing) the fuel vapors 117 from the fuel vapor sorbent material 106. The air and released fuel vapors 117 are routed to the intake manifold by the purge line 112, and mixed with the primary sources of air and fuel. The combined sources of air and fuel are ultimately provided to the engine cylinders for combustion.

A control module 116 is coupled in communication with the vent valve 110 and the purge valve 114 to control each. The control module 116 is depicted schematically in FIG. 1 as a stand-alone electronic control unit (ECU). However, as a practical matter, the control module 116 may be incorporated within a more robust ECU, such as the powertrain control module (PCM) or the engine control module (ECM) of a motor vehicle. Alternatively, the control module 116 could be distributed across multiple ECUs.

Purge valve 114, is modulated between closed and open by the control module 116 at a frequency appropriate to facilitate purging of the EVAP canister 102. In some examples, the control module 116 is programed to purge the EVAP canister in response to certain vehicle operating conditions (e.g., some combination of engine temperature, speed, and load). Numerous strategies are known for controlling the purge valve 114. All suitable purge control strategies and algorithms are contemplated within the scope of the present disclosure.

The EVAP 100 includes a monitoring sub-system designed to estimate the sorption capacity of the EVAP canister 102. The monitoring sub-system includes a first temperature sensor 120 measuring temperature within the EVAP canister 102, and a second temperature sensor 122 measuring temperature of ambient air, each of which is connected to the control module 116. The temperature sensors 120 and 122 can be any type of sensor, including electro-mechanical, resistive, or electronic sensors, including those based on physical contact or convection and radiation temperature measurement principles. In some examples, the temperature sensors 120 and 122 are thermistors or thermocouples.

In one example, the temperature sensor 120 includes a single sensor placed within or otherwise positioned to measure temperature within the EVAP canister 102. The temperature sensor 120 thus measures the temperature of the material 106 within the canister 102. In certain instances, the single sensor is designed to measure the temperature at a single key point within the EVAP canister 102. For instance, the single sensor may be positioned near the inlet of the EVAP canister 102 (at the port opening to the fuel tank vent line 104) or near the outlets of the EVAP canister 102 (at the port opening to the purge line 112 or the air intake/vent line 108). In another example, the temperature sensor 120 includes more than one temperature sensor 120 positioned to measure at different locations throughout the EVAP canister 102. The multiple temperature sensors can provide a temperature profile and/or an average temperature of the EVAP canister 102. The temperature sensor 122 can be a conventional outside air temperature (OAT) sensor mounted outside the passenger compartment of the vehicle, or any other type of temperature sensor.

The control module 116 is coupled in communication with each of the temperature sensors 120 and 122 to receive sensory output from the sensors. The control module compares the actual temperature within the EVAP canister 102 (as reflected by sensory output from the temperature sensor 120) to the ambient temperature (as reflected by sensory output from the temperature sensor 122) to establish a relative temperature of the EVAP canister 102. In certain instances, the control module 116 receives sensory output from the fuel quantity sensor 21 and can determine the amount of vapors passed through the EVAP canister 102 during the loading operations based on the change in the amount of fuel in the fuel tank 10. In certain instances, the control module 116 receives sensory output from the purge flow meter 115 and can determine the amount of vapors passed through the EVAP canister 102 during the purge operations based on the flow rate of the vapors passed through the purge line 112 and the characteristics of the purge line 112. As described below, the control module 116 determines the sorption capacity of the EVAP canister 102 by monitoring the relative temperature of the EVAP canister 102 and the amount of vapors passed through the EVAP canister 102 during the periodic loading and purging operations. As used herein “sorption capacity” refers the total mass of fuel vapor/raw hydrocarbons that can be releasably captured (either absorbed or adsorbed) by the EVAP canister 102.

The magnitude of the change in temperature of the sorbent material 106 via the temperature sensor(s) 120 during loading or purging is used to determine the sorption capacity of the sorbent material 106. As one example, sorption of the fuel vapors 16 onto surfaces of the sorbent material 106 produces heat as a by-product of the phase change of the fuel vapors. Thus, during loading, the relative temperature of the sorbent material 106 increases in proportion to the amount of fuel vapor absorbed/adsorbed. Likewise, during purging, the relative temperature of the sorbent material 106 decreases in proportion to the amount of fuel vapor desorbed.

The relationship between the magnitude of change in temperature and the sorption/desorption of fuel may depend on numerous factors, including canister geometry, fuel type, ambient temperature, fuel vapor temperature 22 and composition of the sorption material. The sorption capacity of the sorbent material 106 corresponds to the magnitude of temperature increase and decrease during loading and purging respectively, and the amount of vapors passed through the canister.

In some examples, a correlation based on empirical data can be used to convert the observed increase or decrease in temperature within the EVAP canister 102 to a value representing sorption capacity. The correlation can be provided in the form of an empirical formula executed by the processor of the control module 116, or in the form of a look-up table stored in the memory of the control module 116. To determine if the EVAP canister 102 is functioning properly (the sorbent material can adsorb/absorb sufficient hydrocarbons to allow the vehicle to pass a certification or an in-use evaporative emissions compliance test), the control module 116 can compare a recently calculated sorption capacity to a predetermined threshold value. If the calculated sorption capacity is greater than the threshold value, the EVAP canister 102 is deemed to be functioning properly. If the computed sorption capacity is less than the threshold value, the EVAP canister 102 is deemed to be malfunctioning.

In some examples, the control module 116 is programmed to determine whether the EVAP canister 102 is malfunctioning by directly observing the magnitude of temperature change of the sorbent material 106, for a given amount of vapors, during loading or purging. In such examples, the control module 116 is pre-programed with threshold values of temperature change or rate of change applicable during loading and purging respectively, for different conditions. The threshold values correspond to an acceptable sorption capacity of the EVAP canister 102. Thus, for example, when the magnitude of temperature increases within the EVAP canister 102 during loading is below a threshold value stored in memory of the control module 116, the EVAP canister is deemed to be malfunctioning.

In some examples, the threshold value for sorption capacity is a function of the amount of fuel (14) added to the fuel tank 10 as determined by a fuel quantity sender unit 21 and the control module 116. When fuel (14) is added to the fuel tank 10, fuel vapors 16 are displaced and pushed into the EVAP canister 102. The amount of fuel vapor 16 loaded into the EVAP canister 102 is proportional to the amount of added fuel (14) as determined by the fuel quantity sender unit 21 and the control module 116. The threshold value for sorption capacity can be calculated based on the magnitude of temperature change of the sorbent material 106, the amount of fuel vapor 16 loaded into the EVAP canister 102 and other factors such as ambient temperature.

In some examples, the threshold value for sorption capacity is a function of the amount of vapors exhausted through the purge line 112 as determined by the purge flow meter 115 and the control module 116. The amount of vapors purged from the EVAP canister 102 can be determined from the flow rate through the purge line 112, as measured by the purge flow meter 115, the cross-sectional area of the purge line 112 and the temperature. The threshold value for sorption capacity can be calculated based on the magnitude of temperature change of the sorbent material 106, the amount of fuel vapor purged from the EVAP canister 102 through the purge line 112 and other factors.

In some examples, if the control module 116 determines that the EVAP canister 102 is malfunctioning, an indication light (e.g., the malfunction indicator light) is illuminated to indicate there is a problem with the evaporative emissions control system and a diagnostic trouble code (DTC) is set by the OBDII system to inform technicians of the problem. The determination may be part of the evaporative emissions control system monitoring as part of OBDII. In some examples, the control module 116 may alter the purge strategies for relieving the EVAP canister 102 in response to determining that the canister is malfunctioning. For example, if the EVAP canister 102 is not absorbing/adsorbing a sufficient amount of hydrocarbons from the fuel vapors 16, the control module 116 may open the purge valve 114 more frequently and/or for a longer duration. Other ECUs on the motor vehicle may also receive a signal indicating that the EVAP canister 102 is malfunctioning and appropriately alter other vehicle operations. For example, the ECM may alter the stoichiometry of the air-fuel mixture to accommodate for the decrease in fuel vapors recovered from the malfunctioning EVAP canister 102.

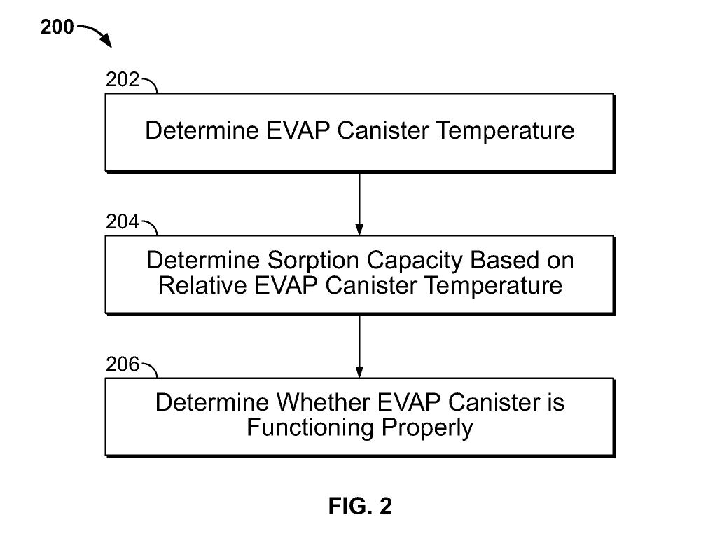

FIG. 2 is a flow chart illustrating a method 200 of monitoring an evaporative emission canister. The method 200 can be implemented, for example, in connection with the EVAP system 100 shown in FIG. 1. At operation 202, the temperature within the EVAP canister is determined. For example, one or more sensors positioned within the EVAP canister can measure the interior temperature and provide sensory output to the control module. In certain instances, an outside air temperature sensor can be used to measure an ambient temperature and provide sensory output to the control module. The control module can compare the ambient temperature to the actual temperature of the EVAP canister to determine a relative temperature. At operation 204, the control module, knowing the amount of vapors loaded or purged from the EVAP canister from a fuel quantity sensor or a purge flow meter, compares the EVAP canister temperature (relative or absolute) before and after refueling or a purge event, and determines the sorption capacity of the EVAP canister. In some examples, the control module alternatively or additionally monitors a rate of change in temperature of the EVAP canister during loading and/or purging operations to determine the sorption capacity. At operation 206, the control module determines if the EVAP canister is functioning properly based on its sorption capacity.

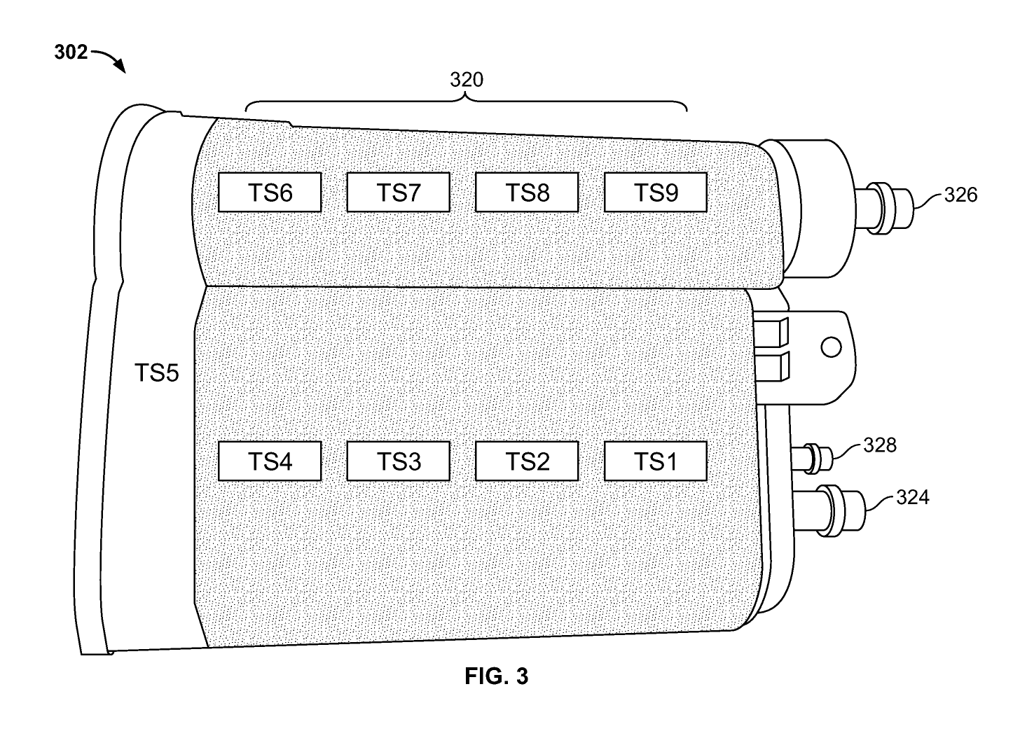

As discussed above, the monitoring sub-system can include a single temperature sensor (120) for measuring within the EVAP canister or an arrangement of multiple temperature sensors. FIG. 3 is a diagram illustrating an example configuration of multiple temperature sensors 320 positioned to measure temperature of the sorbent material within an EVAP canister 302. In this example, the sorbent material is arranged in a U-shape, extending from one end of the canister to an opposing end of the canister and then back. In other instances, the sorbent material can be straight or another shape. The configuration of temperature sensors 320 includes nine sensors labeled TS1 through TS9 located in series along the flow path through the sorbent material between a load port 324 (and a purge port 328) to an intake/vent port 326. The load port 324 connects to the vent line 104 to receive evaporated fuel vapor from the fuel tank 10. The intake/vent port 326 connects to the intake/vent 108 to vent air stripped of hydrocarbons or intake fresh air for purging the EVAP canister 302. The purge port 328 connects to the purge line 112 leading to the engine's intake manifold.

Note that while the present example is illustrated with nine temperature sensors, an EVAP canister 302 configuration with multiple temperature sensors could include fewer or more than nine sensors without departing from the scope of the present disclosure. For example, some implementations of the system employ only two temperature sensors, with one sensor near the load port 324 and the purge port 328 and one other sensor near the intake/vent port 326. One or more additional sensors can be included between the two temperature sensors for additional temperature readings, as desired.

The configuration of temperature sensors 320 provides a temperature-location profile of the EVAP canister 302, which can be monitored over time to determine if the EVAP canister is functioning properly. For example, the temperature profile can be monitored during a purge event and/or during a refueling/load event. The sorbent material within the EVAP canister 302 loads and purges directionally as fuel vapor and air flows through the canister. During a purge event, fresh air is drawn from the intake/vent port 326, travels through the sorbent material towards the purge port 328, which causes stored fuel vapors to desorb from the sorbent material initially near the intake/vent port 326 and progress toward the purge port 328. During a load event, fuel vapor from the fuel tank 10 is drawn from the load port 324 towards the intake/vent port 326, which causes fuel vapors to be absorbed/desorbed by the sorbent material initially near the load port 324 and progress toward the intake/vent port 326. If the sorbent material is operating properly to adsorb/desorb vapors, the directional loading and purging will create a temperature change of the sorbent material that will progress through the sorbent material, coinciding with the material adsorbing/desorbing vapors. For example, as vapors are adsorbed into the sorbent material, the temperature will increase first at TS1, then at TS2, then at TS3 and so on until all sensors have experienced a temperature increase. Similarly, as vapors are desorbed from the sorbent material, the temperature will drop first at TS9, then at TS8, then at TS7 and so on until all sensors have experienced a temperature decrease. The magnitude of the temperature increase/decrease will correspond to the amount of vapors adsorbed/desorbed by the sorbent material adjacent the temperature sensor. Therefore, in this example, in addition to the magnitude of the temperature change of the sorbent material, the temperature profile and how it changes as the EVAP canister 302 is loaded or purged can be used to determine whether the EVAP canister 302 is functioning properly. For example, the temperature profile over the length of the sorbent material can be examined to identify a temperature progressing from TS9 to TS1 during a purge event and a temperature increase progressing from TS1 to TS9 during a load event.

Thus, if multiple temperature sensors are used in the example method of FIG. 2, at operation 202, the multiple temperatures sensors can measure the interior temperature, each at their respective location, and provide sensory output to the control module. In certain instances, the control module can determine a relative temperature at each of the temperature sensor locations, based on the ambient temperature or temperature prior to a load or purge event. At operation 204, the control module, knowing the amount of vapors loaded or purged from the EVAP canister from a fuel quantity sensor or a purge flow meter, compares the EVAP canister temperature before and after refueling or after a purge event, or the rate of temperature change, and determines the sorption capacity of the EVAP canister. The progression of the temperature change through the sorbent material can be analyzed as an indicator, or further indicator, of the sorption capacity of the EVAP canister. For example, if the temperature of some of the temperature sensors reflects an expected temperature change and some do not, then the control module can determine that only portions of the sorbent material are exhibiting diminished sorption capacity. Additionally, if the temperature change does not progress across the temperature sensors, from the load port toward the opposing end of the sorbent material (near the intake/vent port) during a load event or from the purge port to the opposing end of the sorbent material (near the load port) during a purge event, then the control module can determine that the sorbent material is fouled or the canister could be physically damaged.

A number of embodiments of the invention have been described. Nevertheless, it will be understood that various modifications may be made.

What is claimed is:

1. A monitoring sub-system coupled to an evaporative emission canister fluidically coupled to a fuel tank and an engine, comprising:
a temperature sensor positioned to measure temperature within the evaporative emission canister; and
a module coupled to receive sensory output from the temperature sensor and configured to determine a sorption capacity of the evaporative emission canister based on the received sensory output.

2. The monitoring sub-system of claim 1, wherein the temperature sensor is positioned to respond to temperature changes caused by sorption interaction between fuel vapors emanating from the fuel tank and a fuel sorbent material contained within the evaporative emission canister.

3. The monitoring sub-system of claim 1, wherein the temperature sensor comprises a plurality of sensors positioned to measure temperature at different locations within the evaporative emission canister.

4. The monitoring sub-system of claim 3, wherein the module is configured to monitor the sorption capacity based on a location of a change in temperature of the evaporative emission canister.

5. The monitoring sub-system of claim 1, wherein the module is configured to monitor the sorption capacity based on a change in temperature of the evaporative emission canister.

6. The monitoring sub-system of claim 1, wherein the module is configured to monitor the sorption capacity based on a rate of a change in temperature of the evaporative emission canister.

7. The monitoring sub-system of claim 1, wherein the module is coupled to receive sensory output from a fuel quantity sensor, the fuel quantity sensor measures quantity of fuel in the fuel tank, and
the module is configured to monitor a sorption capacity of the evaporative emission canister based on the received sensory output from the fuel quantity sensor.

8. The monitoring sub-system of claim 1, wherein the module is coupled to receive sensory output from a purge flow meter, the purge flow meter measures the flow rate of vapors expelled from the evaporative emission canister through a purge line, and
the module configured to monitor a sorption capacity of the evaporative emission canister based on the received sensory output from the purge flow meter.

9. The monitoring sub-system of claim 1, wherein the module is configured to determine whether the evaporative emission canister is malfunctioning by comparing the sorption capacity value to a predetermined threshold value.

10. The monitoring sub-system of claim 9, wherein the module is configured to activate a malfunction indicator light in response to determining that the evaporative emission canister is malfunctioning.

11. The monitoring sub-system of claim 1, wherein the module is configured to monitor the sorption capacity by:
comparing sensory output from the temperature sensor to sensory output from an ambient temperature sensor to determine a relative temperature of the evaporative emission canister;
monitoring a change in the relative temperature as fuel vapors emanating from the fuel tank enter the evaporative emission canister; and
determining a sorption capacity based on a correlation between a magnitude of the change in relative temperature to a sorption capacity value.

12. A method of monitoring an evaporative emission canister fluidically coupled to a fuel tank and an engine, the method comprising:
receiving a measurement of a temperature within the evaporative emission canister; and
determining a sorption capacity of the evaporative emission canister based on a change in temperature of the evaporative emission canister as fuel vapors are loaded or purged from the evaporative emission canister.

13. The method of claim 12, wherein receiving a measurement of a temperature within the evaporative emission canister comprises receiving measurements of temperature at a plurality of different locations within the evaporative emission canister; and
wherein determining a sorption capacity of the evaporative emission canister comprises determining a sorption capacity of the evaporative emission canister based on a change in temperature of the evaporative emission canister at the plurality of different locations within the evaporative emission canister as fuel vapors are loaded or purged from the evaporative emission canister.

14. The method of claim 13, wherein determining a sorption capacity of the evaporative emission canister comprises determining a sorption capacity of the evaporative emission canister based on the location of the changes in temperature.

15. The method of claim 12, wherein determining a sorption capacity of the evaporative emission canister comprises comparing the change in temperature to empirical data corresponding to the evaporative emission canister.

16. The method of claim 12, comprising determining whether the evaporative emission canister is malfunctioning by comparing the sorption capacity to a predetermined threshold value.

17. The method of claim 12, comprising determining a sorption capacity of the evaporative emission canister based on a correlation between a change in a temperature of the evaporative emission canister, as fuel vapors are desorbed from the evaporative emission canister, to a sorption capacity of the evaporative emission canister.

18. The method of claim 12, comprising determining a sorption capacity of the evaporative emission canister based on a correlation between a rate of change in temperature of the evaporative emission canister to a sorption capacity of the evaporative emission canister.

19. A monitoring sub-system coupled to an evaporative emission canister, comprising:
a sensor responsive to changes in temperature within the evaporative emission canister; and
a module configured to monitor whether the evaporative emission canister is malfunctioning based on sensory output received from the sensor.

20. The monitoring sub-system of claim 19, comprising a plurality of sensors responsive to changes in temperature within the evaporative emission canister.

21. The monitoring sub-system of claim 19, wherein the module is configured to determine whether the evaporative emission canister is malfunctioning by determining whether a magnitude of a change in temperature within the evaporative emission canister, as sensed by the sensor, is greater than a predetermined threshold.
